(19) United States
(12) Patent Application Publication
(10) Pub. No.: US 2021/0266063 A1
(43) Pub. Date: Aug. 26, 2021

(54) INTEGRATED PHOTONIC MICROWAVE SAMPLING SYSTEM

(71) Applicant: IMRA America, Inc., Ann Arbor, MI (US)

(72) Inventor: Martin E. Fermann, Dexter, MI (US)

(21) Appl. No.: 17/183,054

(22) Filed: Feb. 23, 2021

Related U.S. Application Data
(60) Provisional application No. 62/981,852, filed on Feb. 26, 2020.

(51) Int. Cl. H04B 10/073; H04J 14/02

(52) U.S. Cl. CPC H04B 10/073; H04B 2210/006; H04J 14/0227

(57) ABSTRACT

Examples of systems and methods for integrated photonic broadband microwave receivers and transceivers are disclosed based on integrated coherent dual optical frequency combs. In some cases, when the system is configured as a receiver, the microwave spectrum of the input signal can be sliced into several spectral segments for low-bandwidth detection and analysis. In some cases, when the system is configured as a transmitter, multiple radio frequency (RF) carriers can be generated, which can be coherently added or encoded independently for transmission of individual microwave bands. In some systems, the optics-related functionalities can be achieved via integrated optic technology, for example, based on silicon photonics, providing tremendous possibilities for mass-production with significantly reduced system footprint.

### CLAIM OF PRIORITY

This application claims the benefit of priority to U.S. Provisional Appl. Nos. 62/981,852 filed on Feb. 26, 2020, which is incorporated in its entirety by reference herein.

### BACKGROUND

### Field

The present disclosure relates generally to photonic systems and more particularly to integrated microwave photonic sampling systems.

### DESCRIPTION OF THE RELATED ART

Radio frequency (RF) signal analyzers utilizing photonic channelization based on wavelength-division-multiplexing (WDM) have been developed. Time-division-multiplexing (TDM)-based microwave channelizers have also been developed. Optical sampling systems for RF signals have also been developed. Such systems can have limitations.

### SUMMARY

In certain embodiments, a microwave receiver system comprises at least one electro-optic modulator configured to receive a microwave signal under test (SUT) and to modulate the SUT onto at least one comb line of a first optical frequency comb having a first repetition rate. The microwave receiver system further comprises a first wavelength division demultiplexing system configured to receive the at least one modulated comb line from the first optical frequency comb as a first optical input and to separate the first optical input into a first set of wavelength channels. The microwave receiver system further comprises a second wavelength division demultiplexing system configured to receive at least one comb line of a second optical frequency comb as a second optical input and to separate the second optical input into a second set of wavelength channels. The second optical frequency comb has a second repetition rate different from the first repetition rate. The second set of wavelength channels spectrally overlaps the first set of wavelength channels. The microwave receiver system further comprises a set of optical-to-electrical converters configured to generate electrical signals indicative of optical interference between the first set of wavelength channels and the second set of wavelength channels. The microwave receiver system further comprises a phase monitoring system configured to control and/or monitor the optical interference between the first set of wavelength channels and the second set of wavelength channels in response to the electrical signals.

In certain embodiments, a microwave receiver configured to receive a microwave signal under test is provided. The microwave receiver comprises a first wavelength-division demultiplexer configured to receive at least one comb line from a first optical frequency comb as a first optical input and to separate the first optical input into a first set of wavelength channels, the first optical frequency comb having a first repetition rate. The microwave receiver further comprises a second wavelength-division demultiplexer configured to receive at least one comb line from a second optical frequency comb as a second optical input and to separate the second optical input into a second set of wavelength channels, the second optical frequency comb having a second repetition rate different from the first repetition rate. The microwave receiver further comprises a set of optical-to-electrical converters configured to generate electrical signals indicative of optical interference between the first set of wavelength channels and the second set of wavelength channels. The microwave receiver further comprises a phase monitoring system configured to control and/or monitor the optical interference between the first set of wavelength channels and the second set of wavelength channels. The microwave receiver further comprises a set of analog to digital converters configured to receive the electrical signals and to produce a set of digitized outputs. The microwave receiver further comprises a digital signal processor configured to receive the set of digitized outputs and to produce an output indicative of at least an amplitude and/or a phase of the microwave signal under test.

In certain embodiments, a phase coherent dual comb system comprises a dual comb generator configured to generate a first comb and a second comb. The first comb comprises a first set of comb lines with a first repetition rate and the second comb comprising a second set of comb lines with a second repetition rate different from the first repetition rate. The phase coherent dual comb system further comprises at least one detector configured to record a first interference signal of two combs lines originating from the first and second combs at a first location in optical frequency space. The phase coherent dual comb system further comprises a control system configured to use the first interference signal to stabilize a repetition rate difference between the first comb and the second comb and/or a difference in carrier envelope offset frequency between the first comb and the second comb.

In certain embodiments, a photonics-based microwave receiver system comprises a dual comb generator comprising a 1st comb and a 2nd comb, said 1st comb and said 2nd comb configured to operate at different repetition rates, and at least one electro-optic modulator configured to receive a microwave signal under test (SUT) and to modulate the SUT onto at least one of the comb lines from said 1st comb. The microwave receiver system further comprises a first wavelength division multiplexing (WDM) system configured to receive a first optical input directly traceable to an output of said 1st comb, the first WDM system configured to separate the first optical input into a 1^{st} set of wavelength channels. The microwave receiver system further comprises a second wavelength division multiplexing (WDM) system configured to receive a second optical input directly traceable to an output of said 2nd comb, the second WDM system configured to separate the second optical input into a 2^{nd} set of wavelength channels, said 1^{st} and 2^{nd} set of wavelength channels configured to substantially overlap spectrally. The output of said 1^{st} and 2^{nd} set of wavelength channels are further directed to a substantially corresponding set of optical-to-electrical converters (OECs), said set of OECs configured to record optical interference signals between said 1^{st} and 2^{nd} set of wavelength channels and to convert their inputs to electrical signals. The microwave receiver system further comprises a system to control or monitor the optical phase of said interference signals.

In certain embodiments, a microwave receiver configured to receive a microwave signal under test (SUT) is provided. The microwave receiver comprises a dual comb generator comprising a 1st comb and a 2nd comb, said 1st comb and said 2nd comb configured to operate at different repetition rates. The microwave receiver further comprises a 1^{st} WDM system configured to receive a first optical input directly traceable to an output of said 1st comb, and to separate the first optical input into a first set of wavelength channels. The microwave receiver further comprises a 2^{nd} WDM system configured to receive a second optical input directly traceable to an output of said 2^{nd} comb, and to separate the second optical input into a second set of wavelength channels. The microwave receiver further comprises a set of OECs configured to receive, as a first input, a first signal directly traceable to an output of said first set of wavelength channels and, as a 2nd input, a second signal directly traceable to an output of said second set of wavelength channels. The microwave receiver further comprises a system to control and/or monitor an optical phase between said 1^{st} and 2^{nd} inputs to said OECs, said set of OECs configured to convert their input to electrical signals. The microwave receiver further comprises a set of analog to digital converters (ADCs), configured to receive as input a signal directly traceable to an output of at least one of said set of OECs, the set of ADCs configured to produce a set of digitized outputs. The microwave receiver further comprises a digital signal processor configured to receive said set of digitized outputs and to produce an output representative of at least an amplitude and/or a phase of said SUT.

In certain embodiments, a phase coherent dual comb system comprises a dual comb generator comprising a 1st comb and a 2nd comb, said 1st comb and said 2nd comb configured to operate at different repetition rates, said 1st and 2nd combs each comprising a corresponding set of comb lines. The phase coherent dual comb system further comprises at least one detector configured to record a 1^{st} interference signal of two combs lines originating from the 1st and 2nd combs at a first location in optical frequency space, said 1^{st} interference signal being used to stabilize a repetition rate difference between said 1st and 2nd combs and/or a difference in carrier envelope offset frequency between said 1st and 2nd combs

The foregoing summary and the following drawings and detailed description are intended to illustrate non-limiting examples but not to limit the disclosure.

### BRIEF DESCRIPTION OF THE DRAWINGS

FIG. 1 shows a prior art photonic microwave channelization system.

FIG. 2 shows an example photonic microwave sampling system in accordance with certain embodiments described herein.

FIG. 3 shows an example channel allocation of a photonic microwave sampling system based on wavelength-division-multiplexing (WDM) in accordance with certain embodiments described herein.

FIG. 4A demonstrates an example RF spectrum of a microwave signal modulated onto the first comb in accordance with certain embodiments described herein.

FIG. 4B demonstrates an example time domain signal from the first microcomb after modulation of the microwave signal shown in FIG. 4A in accordance with certain embodiments described herein.

FIG. 4C demonstrate example I and Q components of the time domain signal from the first microcomb (after modulation of the microwave signal shown in FIG. 4A) after microwave filtering in accordance with certain embodiments described herein.

FIG. 5 shows another example channel allocation of a photonic microwave sampling system based on wavelength-division-multiplexing (WDM) in accordance with certain embodiments described herein.

FIG. 6 shows another example photonic microwave sampling system in accordance with certain embodiments described herein.

FIG. 7A shows example IQ signals generated by exemplary noise in the spectral overlap region of two exemplary wavelength channels, which are phase shifted by π/4 in accordance with certain embodiments described herein.

FIG. 7B shows example recovered I signals generated by the noise signal depicted in FIG. 7A in the two wavelength channels when the phase shift of π/4 is removed in accordance with certain embodiments described herein.

FIG. 8 shows an example photonic microwave transceiver based on wavelength-division-multiplexing (WDM) in accordance with certain embodiments described herein.

The figures depict various embodiments of the present disclosure for purposes of illustration and are not intended to be limiting. Wherever practicable, similar or like reference numbers or reference labels may be used in the figures and may indicate similar or like functionality.

### DETAILED DESCRIPTION

Overview

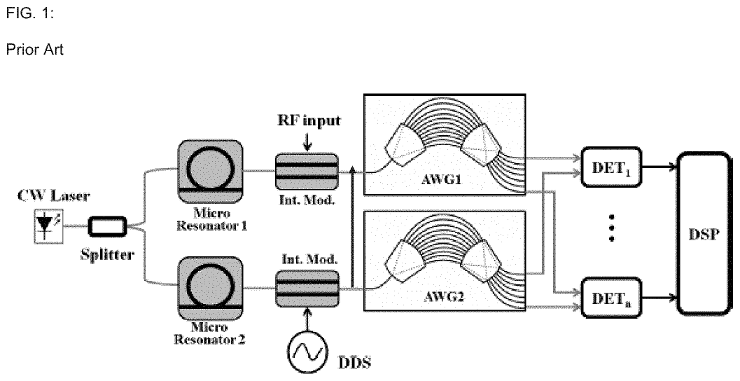

FIG. 1 schematically illustrates a prior art photonic microwave channelization system as disclosed in U.S. Pat. No. 10,498,453 (“the '453 patent”), which is incorporated in its entirety by reference herein. In this system, broadband microwave signals are channelized into spectral slices and detected via heterodyning in the optical domain via a two-comb system. However, the phase information of the microwave signals was lost in the system, as no provisions for phase control or phase recording between the two optical combs was implemented. Thus, the system was only used for RF frequency measurements, but not for full characterization of the amplitude and phase of microwave signals.

Another photonic RF signal receiver or analyzer utilizing photonic channelization based on wavelength-division-multiplexing (WDM) was, for example, discussed in X. Xie et al., “Broadband photonic RF channelization based on coherent optical frequency combs and I/Q demodulators,” IEEE Photonics Journal, vol. 4, No 4, 1196 (2012). In this configuration, two optical combs, whose comb spacings are slightly detuned, are generated from the same continuous-wave (CW) laser. The signal under test (SUT) is modulated onto one of the combs. These two combs are then individually segmented into several channels by the optical wavelength division multiplexers according to the optical frequency. Channels with the same optical frequencies are subsequently mixed for balanced photo-detection. Also, in this system, the phase information of the microwave signals was not preserved, and the system was only used for RF frequency measurements, but not for full characterization of amplitude and phase of microwave signal. Moreover, integration of such a system using integrated optic components was not considered.

Optical sampling systems for microwave signal are well-documented in the literature, for example, in U.S. Pat. No. 8,165,440 (“the '440 patent”), which is incorporated in its entirety by reference herein, where time—interleaving in conjunction with wavelength-division multiplexing was used to enable high bandwidth sampling with an array of low-bandwidth sampling cards. However, full amplitude and phase measurement of an input RF signal was not described. In a more recent example of an optical sampling system disclosed by U.S. Pat. No. 8,768,180 (“the '180 patent”), nonlinear optical mixing between different coherent combinations of signal pulses and a cw local oscillator with an additional probe pulse are utilized for the full recovery of phase and amplitude information of an optical input signal. However, generally, the requirement for nonlinear interactions raises the laser power requirements and can add signal distortions, which limits the utility of such an approach. In yet another example disclosed by U.S. Pat. No. 8,686,712 (“the '712 patent”), accurate optical sampling can be obtained via dispersive time stretching of the signal under test, allowing for signal reconstruction with low bandwidth analog to digital converters. The implementation of time stretching, however, has the fundamental disadvantage that the recording time is limited, as only limited segments of time can be stretched.

The '440 and '712 patents can be viewed as different implementations of time inter-leaving in the optical domain to allow sampling of a high optical bandwidth signal. In contrast, the '453 patent and Xie et al. can be viewed as examples of spectral interleaving. Another example of spectral interleaving for optical sampling was discussed by N. K. Fontaine et al., “Real-time full-field arbitrary optical waveform,” Nature Photonics, vol. 4, pp. 248-254 (2010). However, in this example, the measurement of microwave signals was not considered, moreover, the method relied on the detection of homodyne beats, which meant that no reduction of required sampling rate for a high bandwidth signal (while allowing for accurate signal recording) was achievable.

Therefore, no solutions for photonics-based simultaneous sampling of the phase and amplitude of high bandwidth microwave signals via spectral interleaving exist yet. In contrast, spectral interleaving is well known in microwave technology as a tool to enhance the performance of high bandwidth sampling oscilloscopes, as, for example, described in Peter Pupalaikis, “Digital Bandwidth Interleaving,” LeCroy technical brief (2010) and “Techniques for Extending Real-Time Oscilloscope Bandwidth,” Tektronix Technical Report (2014).

In the present disclosure, examples of integrated photonic microwave systems that overcome some or all of the above-mentioned limitations of the foregoing are described.

Certain embodiments described herein advantageously provide compact broadband sampling systems configured to be utilized with the rapid development of broadband radio frequency technology, which can be extremely difficult for conventional techniques.

The present disclosure describes example microwave photonic systems adapted to the sampling of broadband RF signals. In certain embodiments, the example systems are configured to provide various functionalities including, but not limited to, optical sampling, arbitrary waveform generation, and microwave transceivers. In at least some of the example sampling and transceiver systems described herein, all of the optics-related functionalities of the systems are achieved via the use of compact integrated optic devices. The sampling system can, for example, be based on silicon photonics, silica nitride or diamond microstructures, just to name a few examples, providing advantages for mass production of such example systems with significantly reduced system footprints.

In an example embodiment, output from a continuous wave (CW) laser at a carrier frequency f_{cw} is split into first and second output arms (e.g., via an optical beam splitter or coupler), generating a first output propagating along the first output arm and a second output propagating along the second output arm. Each of the first output and the second output can be independently frequency shifted. By appropriate selection of a first frequency shift applied to the first output, the first output is transformed into a first optical frequency comb (OFC1) with a first comb spacing of Δ₁ by an integrated optical comb generator comprising, for example, a first integrated micro-ring resonator. OFC1 is subsequently modulated by an electro-optical IQ modulator, which can be, for example, based on two nested Mach-Zehnder modulators (MZMs), such that the resulting amplitude modulation of each MZM provides the in-phase (I) and quadrature-(Q) phase component of the applied RF signals, when both MZMs are made to interfere with a phase shift of π/2. When driven by an external RF signal that is inputted to the IQ modulator, the IQ modulator converts the RF signal from the RF domain to the optical domain as side band(s) to each comb line of OFC1. The optical signals are then fed into a first wavelength-division de-multiplexer (WDM1), in which the optical spectrum is sliced into several segments, each segment having a unique frequency coverage.

In the example embodiment, the second output of the CW laser is transformed into a second optical frequency comb (OFC2) by appropriate selection of a second frequency shift applied to the second output, OFC2 having a detuned second comb spacing Δ₂ different than the first comb spacing Δ₁ of OFC1, where δfᵣₑₚ=Δ₂−Δ₁. OFC2 can be generated in the same way as OFC1 by using integrated optical devices, such as a second integrated micro-ring resonator. The OFC2 output is then passed through a second wavelength-division de-multiplexer (WDM2), whose frequency allocation can be the same as that of WDM1.

In an example embodiment, two wavelength channels of WDM1 and WDM2 having the same frequency allocation are combined by, for example, an optical coupler or a 90° optical hybrid. The combined optical signal is converted to the electrical domain by an optical-to-electrical converter (OEC) such as a photodetector or a dual-input balanced photodetector. Optionally, an analog-to-digital converter (ADC) is placed after the OEC for each wavelength channel, whose output is combined in a digital signal processing (DSP) unit for data acquisition and analysis. To record multiple (e.g., all) of the wavelength channels, an array of detectors is used, where each detector is recording wavelength channels at different optical frequencies.

In the example embodiment, the two frequency shifters can be used for long-term locking of the two cw laser frequencies to the two microresonators, as for example disclosed in PCT Appl. No. PCT/US2019/044992 (“the '992 application”), which is incorporated in its entirety by reference herein, and the two microresonators can further be selected to have different carrier envelope offset frequencies, f_{ceo1} and f_{ceo2}, with δf_{ceo}=f_{ceo1}−f_{ceo2}. As disclosed in the '992 application, when locking a cw laser frequency to a microresonator, a frequency shifter can be used to generate a pump frequency matched to the resonance offset frequency (ROF) of the microresonator (where ROF is the difference between the pump laser frequency and the cavity resonance frequency). The two microresonators can further be equipped with heaters (e.g., micro-heaters), which allow for further control of the microresonator resonance frequencies and microresonator comb spacings Δ₁ and Δ₂. For example, the first microresonator heater can be used to stabilize the relative frequency difference of a first pair of comb lines f₁₁, f₂₁ (originating from the two microresonators) at a first location in frequency space and a second pair of comb lines f₂₁, f₂₂ (originating from the two microresonators) at a second location in frequency space, where the two locations in frequency space are preferably separated by at least several comb spacings Δ. In this fashion, the two frequency combs can be phase locked to each other, where both δfᵣₑₚ and Δf_{ceo} are stabilized.

For optical sampling in accordance with certain embodiments described herein, it is further advantageous to stabilize the relative optical phases of the two signals, which are combined (or interfered) in each wavelength channel, where each wavelength channel is further recorded by a separate detector. For relative optical phase stabilization, a fraction of the output of the first microresonator can be phase modulated at a phase modulation frequency Fₚₕₐₛₑ and combined with the output of the second microresonator and also directed through WDM2. Via observation and phase locking of the heterodyne beats Fₚₕₐₛₑ in each wavelength channel, an error signal can be directed to an array of phase shifters (one phase shifter for each wavelength channel) and the optical phase of the two optical signals interfering in each wavelength channel can be stabilized.

As an alternative to stabilizing the relative optical phases of the two signals, which are combined (or interfered) in each wavelength channel, the optical phase difference can also be recorded and subsequently accounted for in signal reproduction. For phase difference recording, the wavelength channels can be each designed to overlap with the next neighbor channel. In an example embodiment, signals A and B in channels I and II are recorded and the two channels overlap in the optical domain in overlap region O. The microwave signal recorded by a first detector attached to channel 1 in the overlap region is then O1 and the microwave signal recorded by a second detector attached to channel 2 in the overlap region is then O2. The phase difference of signals O1, O2 then corresponds to the optical phase difference of the interference signals recorded in the two channels. This phase difference can be measured and accounted for in microwave signal reproduction. For measurement of the phase difference, a microwave signal can be present in overlap region O. However, the phase difference can also be measured with the use of a noise signal provided the origin of the noise in region O is correlated between the two channels.

Note that for full signal reproduction, the control of the optical phase between individual wavelength channels can also be implemented. However, the RF phase imparted onto the individual channels by the IQ modulator and detected by the array of photodetectors is, to first order, not affected by relative optical phase fluctuations between individual wavelength channels, and is mainly determined by relatively slow RF phase fluctuations arising, for example, from different RF cable lengths, which are typically small in a compact optical device. Moreover, any such RF phase variations can be accounted for in a calibration procedure.

In an example embodiment in which the microwave photonics system is configured as a broadband RF sampling system, the comb spacings of the two combs OFC1 (Ai) and OFC2 (Δ₂) are separated at a predetermined difference δf_{re p}=|∴₁−Δ₂ I. The broadband input RF signal is modulated to the optical comb lines of OFC1 through an IQ modulator. The mismatch between the comb spacings of OFC1 and OFC2, in combination with optical wavelength de-multiplexing, spectrally slices the input signal into N segments at a frequency separation of S_{f}, where N is the total number of WDM channels. RF down-conversion is achieved by optical heterodyning of the segmented RF-signal induced sidebands of OFC1 and the comb lines of OFC2 at the photo-detectors attached to each of the N WDM channels, enabling sampling of broadband microwave signals with low-bandwidth ADCs.

### Example Photonic Microwave Sampling System

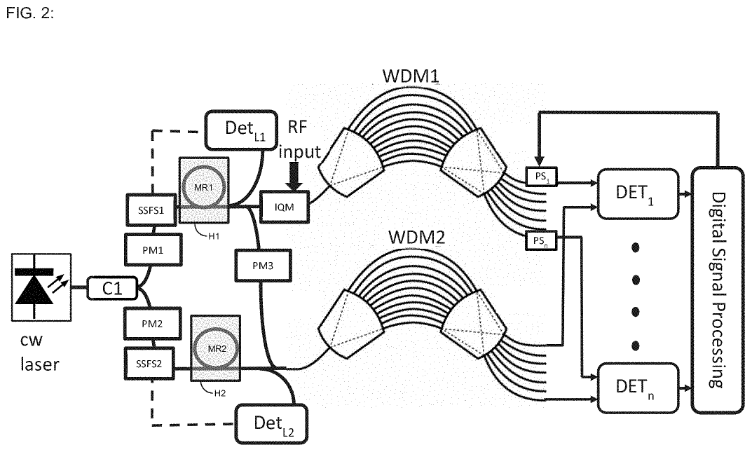

Certain embodiments described herein relate generally to an integrated photonics microwave sampling system that utilizes wavelength-division multiplexing. An example photonics system in accordance with certain embodiments described herein is schematically shown in FIG. 2. As shown in FIG. 2, the output of a single longitudinal mode CW laser is split into two parts by an optical coupler C1, generating a first output and a second output. Each of the first output and the second output can be independently frequency shifted by, for example, a first single sideband frequency shifter SSF1 and a second single sideband frequency shifter SSF2, respectively. By appropriate selection of the first frequency shift of the first output by SSF1, the first output is transformed into a first optical frequency comb (OFC1) with a first comb spacing of Ai by an integrated optical comb generator comprising, for example, a first integrated micro-ring resonator (e.g., microresonator MR1). The comb OFC1 is subsequently modulated by an electro-optical IQ modulator (IQM). When driven by an external RF signal (RF input), the IQ modulator converts the RF input from the RF domain to the optical domain as side band(s) to each comb line of OFC1. Generally, this external RF signal constitutes the RF signal under test (SUT), which certain embodiments described herein are configured to convert into the digital domain. The optical signal generated by the IQM is then fed into a first wavelength-division de-multiplexer (WDM1), in which the optical spectrum is sliced into several segments, each segment having a unique frequency coverage.

In the example embodiment of FIG. 2, the second output of the CW laser is transformed into an optical frequency comb (OFC2) by appropriate selection of the second frequency shift of the second output by SSF2 with a detuned second comb spacing Δ₂ different than the first comb spacing Δ₁ of OFC1, where δfᵣₑₚ=Δ₂−Δ₁. OFC2 comb can be generated in the same way as OFC1 by using integrated optical devices, such as a micro-ring resonator (e.g., microresonator MR2). The OFC2 output is then passed through a second wavelength-division de-multiplexer (WDM2), having a frequency allocation that can be the same as that of WDM1. Here WDM1 and WDM2 are depicted as arrayed waveguide gratings (AWGs), but any form of wavelength-division de-multiplexer can be used.

In an example embodiment, two wavelength channels of WDM1 and WDM2 having the same frequency allocation are combined by, for example, an optical coupler or a 90° optical hybrid. The combined optical signal is converted to the electrical domain by an optical-to-electrical converter (OEC) such as a photodetector or a dual-input balanced photodetector (DET). Optionally, an analog-to-digital converter (ADC) is placed after the OEC for each wavelength channel, the output of which is combined in a digital signal processor (DSP) (e.g., circuit; chip) for data acquisition and analysis. To record multiple (e.g., all) of the wavelength channels, an array of detectors (DET₁-DETₙ) can be used, where each detector is recording wavelength channels at different optical frequencies. Generally, there can be a near one-to-one correspondence between the set of wavelength channels and the set of detectors. However, for certain applications, some wavelength channels may not include a corresponding detector.

For optical sampling, certain embodiments advantageously stabilize the relative optical phases of the two signals from WDM1 and WDM2 respectively, which are combined (or interfered) in each wavelength channel, where each wavelength channel is further recorded by a separate detector. Generally, the two signals generate an optical interference signal and the phase of this interference signal depends on the overall optical phase delay of the two signals experienced from propagation delays through the whole system. Due to temperature fluctuations, the optical phase delay between the two signals fluctuates, which can produce errors in signal reproduction. This phase error can be particularly troublesome when analyzing the signal in more than one wavelength channel, as, for example, can be used for full recording and digitization of the microwave SUT. For optical phase stabilization of the interference signal, a fraction of the output of the first microresonator (MR1) can be phase modulated at a phase modulation frequency Fₚₕₐₛₑ by a third phase modulator (PM3) and combined with the output of the second microresonator (MR2) and also directed through WDM2. Via observation and phase locking of the heterodyne beats Fₚₕₐₛₑ in each wavelength channel, an error signal (e.g., from the DSP) can be directed to an array of phase shifters (PS₁-PSₙ)(one phase shifter for each wavelength channel) and the optical phase of the two optical signals interfering in each wavelength channel can be stabilized.

In an example embodiment in which the microwave photonics system is configured as a broadband RF sampling system, the first and second comb spacings of the two combs OFC1 (Δ₁) and OFC2 (Δ₂) are separated at a predetermined difference δfᵣₑₚ=|Δ₁−Δ₂|. The broadband input RF signal is modulated onto the optical comb lines of OFC1 through the IQ modulator (IQM). The mismatch between the first and second comb spacings of OFC1 and OFC2, respectively, in combination with optical wavelength de-multiplexing, spectrally slices the input signal into N segments at a frequency separation of S_{f}, where N is the total number of WDM channels. RF down-conversion is achieved by optical heterodyning of the segmented RF-signal induced sidebands of OFC1 and the comb lines of OFC2 at the photo-detectors attached to each of the N WDM channels, enabling sampling of broadband microwave signals with low-bandwidth ADCs.

For Pound-Drever-Hall (PDH1) locking of the two microresonators MR1 and MR2, and locking of the two pump lasers to the ROFs of the two combs OFC1 and OFC2, certain embodiments further comprise two additional detectors, Det_{L1} and Det_{L1}, which are configured to receive a fraction of the output of the two microresonators MR1, MR2, respectively, as schematically shown in FIG. 2 (see, also, the '992 application). Briefly, by mixing the signal generated by these additional detectors with the modulation signals (which are applied to the two phase modulators PM1 and PM2) as schematically shown in FIG. 2, suitable control signals can be provided for the two frequency shifters SSFS1 and SSFS2, which can lock the pump laser frequencies to the ROFs of the combs OFC1 and OFC2.

Moreover, for phase locking the two combs OFC1 and OFC2 from the two microresonators MR, MR2 (e.g., microcombs) to each other, two detectors from the detector array shown in FIG. 2 can be used. The first of these two detectors can record the relative frequency difference of a first pair of comb lines f₁₁, f₂₁ via observation of a beat signal, which in turn can be stabilized via a PID loop, involving the generation of an error signal and application of a control signal to a first heater (H1) in thermal communication with the first microresonator. The second of these two detectors can be be used in an analogous fashion to stabilize the frequency difference of a second pair of comb lines f₂₁, f₂₂ at a second location in frequency space using a second heater (H2) in thermal communication with the second microresonator. In this fashion, the two frequency combs OFC1 and OFC2 can be phase locked to each other, where both δfᵣₑₚ and δf_{ceo} are stabilized.

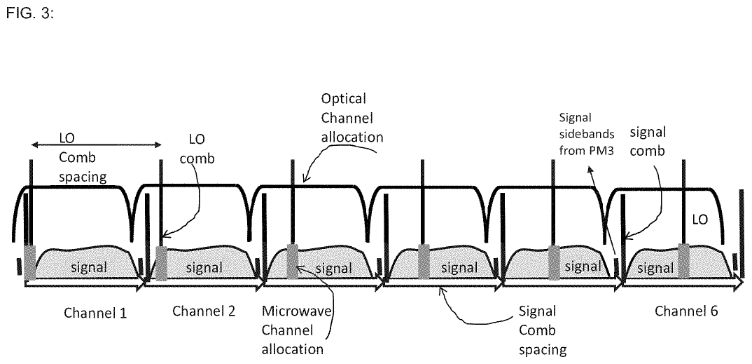

Without intending to be bound or limited by any principle or theory, the working principle of an example microwave photonic sampling system in accordance with certain embodiments described herein, is further illustrated in FIG. 3. For simplicity, two microresonators MR1, MR2 can be phase-locked to each other. The working principle is similar to an optical channelizer as disclosed in the '453 patent, but for the additional capability of full amplitude and phase recovery of an applied RF signal. In FIG. 3, the exemplary comb lines of OFC1 (labeled “signal comb” in FIG. 3) and OFC2 (labeled “LO comb” in FIG. 3 which stands for “local oscillator comb”) are shown. A microwave signal applied to the IQ modulator generates the signal sidebands (labeled “signal” in FIG. 3) on each of the signal comb lines of OFC1. Via the third phase modulator (PM3), another set of signal sidebands (labeled “signal sidebands from PM3 in FIG. 3) close to the signal comb lines is generated. With an appropriate modulator, the signal sidebands from PM3 can be on one side of the signal comb lines of OFC1, as shown in FIG. 3, but generally they are on both sides of the signal comb lines of OFC1. The LO comb lines of OFC2 beat with the signal sidebands generated by the IQ modulator at different spectral slots (labeled “microwave channel allocation” in FIG. 3) allowing recovery of the phase and amplitude information of the microwave signal in that spectral slot via an optical hybrid. These beat signals are in the microwave domain and are isolated from each other via the optical WDM system, having an optical channel allocation as indicated in FIG. 3. While FIG. 3 corresponds to an example embodiment in which WDM1 and WDM2 have the same channel allocation, in certain other embodiments, the channel allocation for WDM1 is different from that of WDM2. In certain embodiments, PM3 allows for optical phase stabilization between the signals arriving on the detector array via WDM1 and WDM2 (as also shown in FIG. 2), where the phase shifters PS₁ to PSₙ are used to compensate for any optical phase fluctuations.

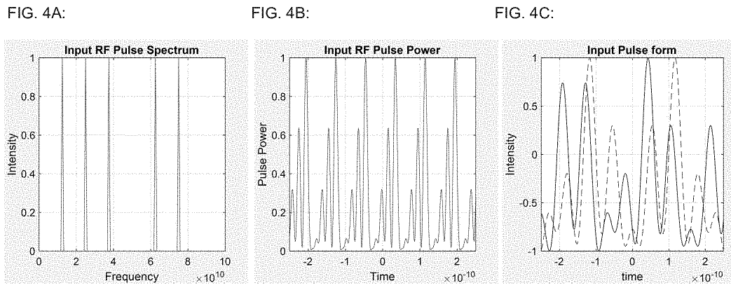

In an example embodiment, the two combs OFC1, OFC2 (e.g., from the two microcombs) are centered at 1.5374 μm (=195 THz). The first comb OFC1 has a first comb spacing of 100 GHz and the second comb OFC2 has a second comb spacing of 120 GHz. An example of the microwave power spectrum of an applied microwave signal to the first comb OFC1 is shown in FIG. 4A. The corresponding time domain signal is shown in FIG. 4B. For simplicity, FIG. 4B shows a repetitive time domain signal, but certain embodiments described herein work in the same fashion for non-repetitive signals as well. In this example, five optical filters with a bandwidth of 100 GHz each cover the spectral range from 195-195.5 THz. The location of the five LO oscillator comb lines can be at 195.00, 195.12, 195.24, 195.36 THz and 195.48 THz. The first LO comb line located at 195.00 THz then serves as the LO for recording the RF signals in the RF band from 0-20 GHz, the second LO comb line located at 195.12 THz serves as the LO for recording the RF signals in the RF band from 20-40 GHz . . . and the fifth LO comb line at 195.48 THz serves as the LO for recording the RF signals from 80-100 GHz. As an example, the I and Q components of the recorded microwave signal in the RF band from 20-40 GHz are shown in FIG. 4C.

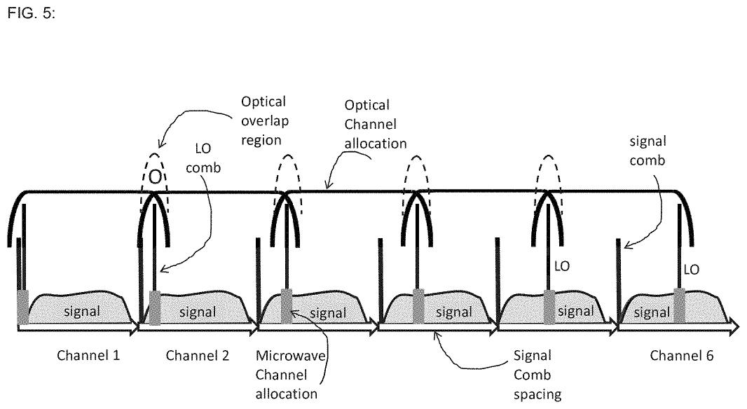

Signal processing can then be used to combine the I/Q components recorded by each detector in each channel and to add them coherently to reproduce the overall microwave signal, where the microwave signals in the higher order channels are frequency shifted appropriately (for example in software) to compensate for the frequency down-conversion previously established by the array of local oscillators. With the implementation of this procedure in certain embodiments, the signal (e.g., shown in FIG. 4B) can be reproduced to a high degree of fidelity.

Whereas the previous example embodiment utilized a phase-locked dual comb signal with optical phase stabilization of the interference signal observed in individual optical channels, certain other embodiments can implement and account for phase fluctuations via phase recording of the optical phase of the interference signals in individual channels in signal reproduction. Without intending to be bound or limited by any principle or theory, the working principle of an example embodiment of the microwave photonic sampling system, employing phase recording is further illustrated in FIG. 5.

For phase difference recording in accordance with certain embodiments described herein, the wavelength channels can be each designed to overlap with the next neighbor channel. Hence the next-neighbor channels overlap in the indicated overlap regions, as schematically illustrated in FIG. 5.

In the example schematically illustrated by FIG. 5, signals A and B in channels 1 and 2, respectively, are recorded and the two channels overlap in the optical domain in the “optical overlap region” O of FIG. 5. The microwave signal (denoted “signal” in FIG. 5), recorded by a first detector attached to channel 1 and originating from the optical overlap region, is then O1_{I} and O1_{Q}, where the subscript “I” indicates the in-phase contribution to the signal and the subscript “Q” indicates the quadrature contribution to the signal. Similarly, the microwave signal recorded by a second detector attached to channel 2 and originating from the optical overlap region is then O2_{I} and O2_{Q}. In certain embodiments, the I and Q contributions of the signal from channel 1 are added (e.g., digitally) to produce a complex signal O1=O1_{I}+i*O1_{Q} and I and Q contributions of the signal from channel 2 are added (e.g., digitally) to produce a complex signal O2=O2_{I}+i*O2_{Q}. The phase difference between signals O1, O2 then corresponds to the optical phase difference of the two channels. In certain embodiments, the phase difference can then be accounted for in microwave signal reproduction to obtain the true microwave signal.

For measurement of the phase difference, in certain embodiments, a microwave signal is present in the optical overlap region O. However, in certain other embodiments, the phase difference can be measured with the use of a noise signal provided the origin of the noise signal in the optical overlap region O is correlated between the two channels.

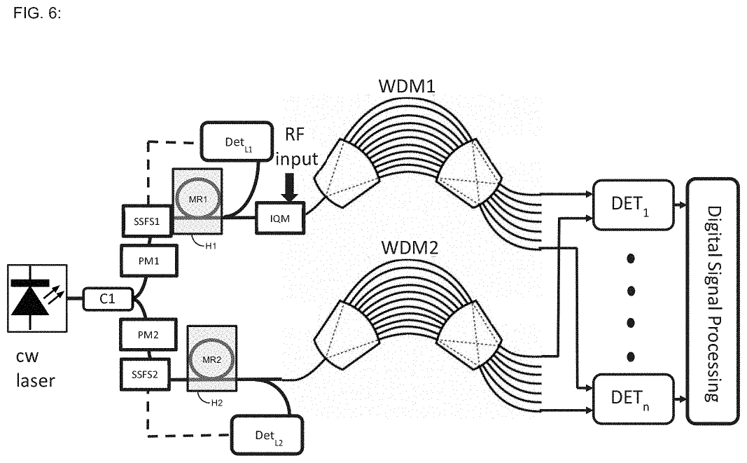

In certain embodiments in which the phase difference of the interfering signals in neighboring channels is recorded rather than stabilized, a simplified example photonic microwave sampling system, as schematically illustrated by FIG. 6, can be used. This simplified example system is similar to the example photonic microwave sampling system schematically illustrated by FIG. 2, but the third phase modulator (PM3) and the phase shifters PS₁ to PS_{N} are omitted from the simplified example system of FIG. 6. In certain other embodiments, it can be advantageous to keep the third phase modulator and/or the phase shifters, for example, to enable a larger range of phase tracking between next neighbor channels and to compensate physically for phase differences in order to improve signal acquisition speed.

In certain embodiments, a calibration signal can be injected into the system via the IQ modulator (IQM) shown in FIG. 6. Once the phase differences between the channels have been established, the calibration signal can be turned off for periods of time, which helps in maximizing the achievable signal to noise ratio of digital sampling.

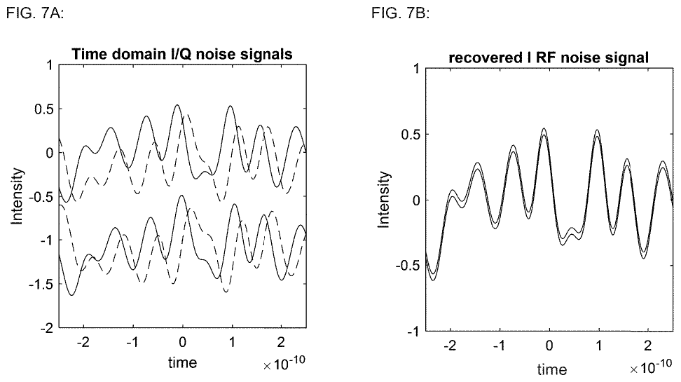

FIGS. 7A and 7B illustrate an example phase recovery in accordance with certain embodiments described herein. FIG. 7A shows the I and Q signals of exemplary white noise in a frequency band from 20-40 GHz, (down-converted to 0-20 GHz) of two channels with a phase difference of π/4. In FIG. 7B, the recovered I signals in both channels are shown, when the phase difference is subtracted. Here the traces are vertically offset for better visibility.

In certain embodiments, as described above, the example photonic microwave sampling systems can be used as optical sampling systems with phase coherent dual comb systems. In certain other embodiments, phase coherence is not required for optical sampling. Certain embodiments utilize other means for recording the difference in carrier envelope offset frequency and repetition rate between the two combs. Systems for tracking carrier envelope offset frequency differences and repetition rate differences between two combs that can be used in accordance with certain embodiments described herein are described in, for example, U.S. Pat. No. 8,477,314. With information on carrier envelope offset frequency and repetition rate differences between two combs, certain embodiments described herein utilize signal processing routines to sample and fully recover complex microwave signals.

While certain embodiments are described herein as utilizing combs generated by microcombs (e.g., microresonators), certain other embodiments can utilize electro-optic or EO combs generated via modulation of a cw laser line with a high bandwidth modulator (see, e.g., the '453 patent). In certain embodiments using two EO combs, phase control between the two combs is not required, therefore, as schematically illustrated in FIG. 5, certain such embodiments do not utilize single-sideband frequency shifters or detectors L1 and L2. Instead, certain such embodiments replace the microresonators MR1 and MR2 with the two EO combs comprising typically one or more phase modulators and one amplitude modulator arranged in sequence. The two EO combs can also be operated with slightly different comb spacings. EO combs are well known in the state of the art and not further discussed here.

The systems of certain embodiments described herein utilize IQ modulators (e.g., as shown in FIGS. 2 and 6) to modulate a microwave signal under test onto the comb lines of one of the combs. Typical IQ modulators have a bandwidth up to 100 GHz, and silicon plasmonic oscillators have been developed that have bandwidths of several hundred GHz, as, for example, described in W. Heni et al., “Plasmonic IQ modulators with attojoule per bit electrical energy consumption,” Nature Communications, (2019). Therefore, in certain such embodiments, the system can be used for sampling of microwave signals also.

As an alternative to direct modulation of an RF signal onto an IQ modulator, in certain embodiments, the RF signal can also be first down-converted to an intermediate frequency and then modulated onto the comb lines. High bandwidth down-conversion can be performed via mixing a high frequency signal with a high frequency local oscillator in, for example, a Schottky diode. For example, a microwave signal at 300 GHz center frequency and a bandwidth of 20 GHz can be down-converted to a center frequency of 20 GHz via mixing with a local microwave oscillator at 280 GHz. Down-conversion of microwave signals to intermediate frequencies is well known in the state of the art and not further described here.

The example systems schematically illustrated in FIGS. 2 and 6 utilize microcombs in the photonic sampling systems. In certain embodiments, the component count of such systems can further be reduced by excluding the single side-band frequency shifters. The rapid frequency shifting used for the initiation of microcombs can, for example, be substituted by direct modulation of the cw laser (see, e.g., in K. Nishimoto et al., “Generation of a microresonator soliton comb pumped by a DFB laser with phase noise measurements,” arXiv preprint arXiv:2002.00736, 2020). Moreover, in certain embodiments, the implementation of pump laser modulation is not required for long-term operation of microcombs (see, e.g., Nishimoto). Hence, in certain embodiments, the rapid frequency shifters, SSFS1 and SSFS2, the optical modulators PM1 and PM2, and the detectors Det_{L1} and Det_{L2} can all be omitted in an optical sampling system in accordance with certain embodiments described herein. Instead, certain embodiments described herein can use pump laser frequency modulation for the initiation of soliton comb operation. In certain embodiments, the heaters H1 and H2 are appropriately adjusted such that the frequency modulation of the cw pump laser can start soliton operation in both resonators simultaneously. Moreover, in certain embodiments, the heaters H1 and H2 can also be used for phase locking of the two microcombs to each other (e.g., via PID loops as discussed herein). In certain embodiments, any of the frequency shifters SSFS1 and SSFS2, the optical modulators PM1 and PM2, and the detectors Det_{L}i and Det_{L2} are retained.

The example systems schematically illustrated in FIGS. 2 and 6 further utilize distinct microcombs. In certain other embodiments, a single microcomb can generate two pulse trains with slightly different repetition rates by, for example, setting up a microcomb with two counter-directional oscillating signals or by exploiting higher-order mode oscillation in the microcomb. Dual comb operation in a single microcomb typically is accompanied by very low phase noise between the oscillating microcomb modes and can therefore allow for phase stable or near phase stable operation without any additional actuators. For example, the example system shown in FIG. 6 can be adapted to accommodate a dual comb system based on a single microresonator, and the two outputs of the microresonator can be directed directly to the two WDM systems without any additional frequency shifters, optical modulators and detectors Det_{L1, L2}. To imprint an RF signal onto one of the outputs, the IQ modulator of certain embodiments is positioned upstream of one of the WDM systems.

A high bandwidth photonic sampling system in accordance with certain embodiments described herein essentially slices a microwave signal into a set of frequency bands, and then frequency down-converts each microwave spectral slice optically to facilitate sampling with reduced requirement on the bandwidth of the analog to digital converters. In certain embodiments, the process can also be reversed, where a number of (e.g., low frequency) microwave spectral slices are coherently combined to produce a high bandwidth microwave signal. For some applications, both functionalities can be present at the same time. Systems allowing for both signal reception as well as signal transmission are typically referred to as transceivers. A non-phase preserving transceiver involving spectral splicing was for example described in the '453 patent.

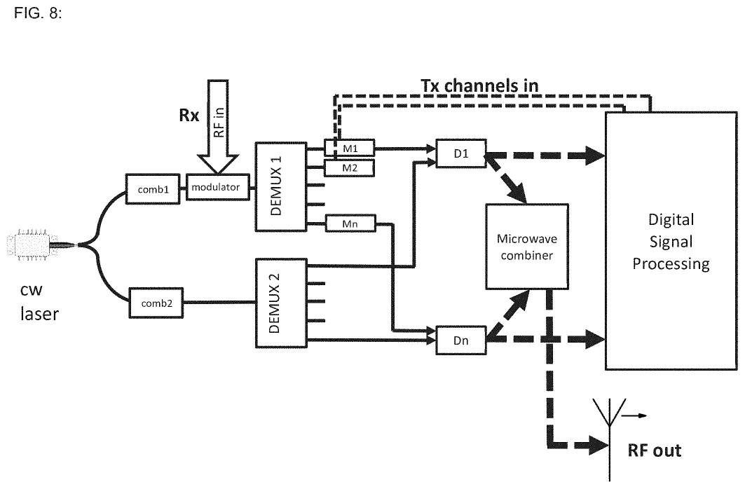

FIG. 8 schematically illustrates an example of a photonic phase preserving transceiver in accordance with certain embodiments described herein. In FIG. 8, the elements for phase control of the two combs are omitted. When two microcombs are used, the same elements as are shown in FIG. 6 can be included for phase control of the two combs. When two EO combs are used, no elements for phase control are needed. However, phase control or phase monitoring between individual channels may still be used.

When operated as a phase coherent receiver Rx in certain embodiments, an external microwave (RF) signal is modulated onto the comb lines by the modulator directly down-stream of comb 1. Optical division de-multiplexers (DEMUX 1 and DEMUX 2, based for example on AWGs) (e.g., similar in arrangement as shown in FIG. 5) can divide the optical spectrum into several optical slices, where each slice contains the signal as side-bands to individual signal comb lines, as well as at least one LO comb line. To track the phase across individual optical spectral slots, each optical spectral slice can also contain two LO comb lines as described herein with respect to FIG. 5. In the Rx configuration, the high bandwidth modulators M1 to Mn can be operated in high pass mode and the detector array D1 to Dn (based on, for example, optical hybrids) can measure the interference signals between the signal and the LO, as described herein with respect to FIG. 5, allowing for full signal reproduction via digital signal processing. In certain embodiments, phase tracking across individual spectral slots can be arranged similarly to the way described with respect to FIG. 5. For clarity, in FIG. 8, optical signal transmission lines are depicted as solid lines and electronic transmission lines are depicted as dashed lines.

When operated as a transmitter, the system of certain embodiments generates a desired microwave signal by dividing the desired microwave signal into n spectral sub-bands via signal processing. These spectral sub-bands are further down-converted in signal processing to cover approximately the same frequency spectral range. Spectral down-conversion is then reversed by spectral upconversion and the upconverted microwave signals in the spectral sub-bands can then be added coherently to generate the desired microwave output signal. When using the system of certain embodiments as a transmitter, it can be advantageous to address and transmit the unconverted microwave signals independently. Therefore, the microwave combiner shown in FIG. 8 can be omitted and the signals from D1 to Dn can be directed to an emitter or a set of emitters directly. Moreover, in certain embodiments, modulators M1 to Mn further allow for inscription of desired modulation formats on such signals. Such multi-channel microwave transceivers were already described in the '453 patent and are not further discussed here.

For example, the desired microwave signal can have a bandwidth of 100 GHz; signal processing can divide the 100 GHz signal into, for example, five spectral slots covering bandwidths from 0-20, 20-40, 40-60, 60-80 and 80-100 GHz. Frequency down-conversion can reduce the spectral range of all five of these channels to 0-20 GHz. Spectral up-conversion can then restore the signal into the original five spectral slots from 0-100 GHz. If desired, these five spectral slots can be coherently combined to produce 100 GHz bandwidth microwave signal.

This operation mode is further described with respect to FIG. 8. A desired microwave signal can be defined by signal processing and digitally downconverted into n signals covering approximately the same spectral microwave range. Modulators M1 to Mn can modulate the digitally down-converted microwave signals in the spectral sub-bands onto the spectrally separated comb lines of comb1. The resulting optical signals can be mixed with the LO oscillator comb lines in detectors D1 and Dn, reversing down-conversion and providing the desired microwave signals split between different microwave channels. If desired, additional modulation formats can be inscribed onto these microwave signals. The individual microwave signals can be directed to output devices, such as antennas for use in, for example, microwave communication systems. In some applications, the microwave signals can also be directed to a microwave combiner to generate a broad bandwidth microwave signal which can then be directed to an output device, such as an antenna.

### Additional Aspects

A photonics based microwave sampling system comprising: a dual comb generator, comprising a 1st comb and a 2nd comb, said 1st comb and said 2nd comb configured to operate at different repetition rates; at least one electro-optic modulator configured to receive a microwave signal under test (SUT) and to modulate the SUT onto at least one of the comb lines from said 1st comb; a first wavelength division multiplexing (WDM) system configured to receive an optical input directly traceable to an output of said 1st comb, the WDM system configured to separate the optical input into a set of wavelength channels; a set of optical-to-electrical converters (OEC) configured to receive as a 1st input a signal directly traceable to an output of said WDM channels and as a 2nd input a signal directly traceable to an output of said 2nd comb, said set of OECs configured to convert their inputs to electrical signals; an arrangement for stabilizing or measuring the optical phase differences between the 1^{st} input and the 2^{nd} input across the wavelength channels; and a set of analog-to-digital converters (ADCs) downstream of said OECs, the output of said ADCs further combined via signal processing to produce an output representative of at least an amplitude or a phase or amplitude and phase of said SUT.

### Additional Considerations

For purposes of summarizing the present invention, certain aspects, advantages and novel features are described herein in several embodiments. It is to be understood, however, that not necessarily all such advantages may be achieved in accordance with any particular embodiment. Thus, the present invention may be embodied or carried out in a manner that achieves one or more advantages without necessarily achieving other advantages as may be taught or suggested herein. It is to be understood that the embodiments are not mutually exclusive, and elements described in connection with one embodiment may be combined with, rearranged, or eliminated from, other embodiments in suitable ways to accomplish desired design objectives. No single feature or group of features is necessary or required for each embodiment.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” or “an” or “the” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), or both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present.

Thus, while only certain embodiments have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A microwave receiver system comprising:
at least one electro-optic modulator configured to receive a microwave signal under test (SUT) and to modulate the SUT onto at least one comb line of a first optical frequency comb having a first repetition rate;
a first wavelength division demultiplexing system configured to receive the at least one modulated comb line from the first optical frequency comb as a first optical input and to separate the first optical input into a first set of wavelength channels;
a second wavelength division demultiplexing system configured to receive at least one comb line of a second optical frequency comb as a second optical input and to separate the second optical input into a second set of wavelength channels, the second optical frequency comb having a second repetition rate different from the first repetition rate, the second set of wavelength channels spectrally overlapping the first set of wavelength channels;
a set of optical-to-electrical converters configured to generate electrical signals indicative of optical interference between the first set of wavelength channels and the second set of wavelength channels; and
a phase monitoring system configured to control and/or monitor the optical interference between the first set of wavelength channels and the second set of wavelength channels in response to the electrical signals.

2. The system according to claim 1, further comprising a single microresonator configured to generate the first optical frequency comb and the second optical frequency comb.

3. The system according to claim 1, further comprising a first microresonator configured to generate the first optical frequency comb and a second microresonator configured to generate the second optical frequency comb.

4. The system according to claim 1, further comprising silicon photonics, silica nitride, diamond microstructures or any other microstructures.

5. The system according to claim 1, wherein the system is configured to be a component of a microwave transceiver.

6. The system according to claim 1, further comprising at least one continuous wave laser configured to inject laser light into at least one comb generator configured to generate at least one of the first optical frequency comb and the second optical frequency comb.

7. The system according to claim 1, wherein the electro-optic modulator comprises an IQ modulator.

8. The system according to claim 1, further comprising:
a set of analog to digital converters configured receive the electrical signals and to produce a set of digitized outputs; and
at least one digital signal processor configured to receive and analyze the set of digitized outputs and to produce an output indicative of an amplitude and/or a phase of the SUT.

9. The system according to claim 8, wherein at least one analog to digital converter of the set of analog to digital converters comprises an I/Q detection system.

10. The system according to claim 8, wherein the system is configured to analyze broadband microwave signals with a bandwidth up to several hundred GHz.

11. The system according to claim 1, further comprising an antenna configured to receive a microwave signal indicative of an electrical signal from at least one optical-to-electrical converter of the set of optical-to-electrical converters, the antenna configured to transmit the microwave signal as radio waves.

12. The system according to claim 1, wherein the system is configured to transmit a broadband microwave signal with a bandwidth up to several hundred GHz.

13. A microwave receiver configured to receive a microwave signal under test, the microwave receiver comprising:
a first wavelength-division demultiplexer configured to receive at least one comb line from a first optical frequency comb as a first optical input and to separate the first optical input into a first set of wavelength channels, the first optical frequency comb having a first repetition rate;
a second wavelength-division demultiplexer configured to receive at least one comb line from a second optical frequency comb as a second optical input and to separate the second optical input into a second set of wavelength channels, the second optical frequency comb having a second repetition rate different from the first repetition rate;
a set of optical-to-electrical converters configured to generate electrical signals indicative of optical interference between the first set of wavelength channels and the second set of wavelength channels;
a phase monitoring system configured to control and/or monitor the optical interference between the first set of wavelength channels and the second set of wavelength channels;
a set of analog to digital converters configured to receive the electrical signals and to produce a set of digitized outputs; and
a digital signal processor configured to receive the set of digitized outputs and to produce an output indicative of at least an amplitude and/or a phase of the microwave signal under test.

14. The microwave receiver according to claim 13, wherein the set of analog to digital converters comprises an I/Q detection system.

15. The microwave receiver according to claim 14, wherein the I/Q detection system comprises an optical hybrid.

16. A phase coherent dual comb system comprising:
a dual comb generator configured to generate a first comb and a second comb, the first comb comprising a first set of comb lines with a first repetition rate and the second comb comprising a second set of comb lines with a second repetition rate different from the first repetition rate;
at least one detector configured to record a first interference signal of two combs lines originating from the first and second combs at a first location in optical frequency space; and
a control system configured to use the first interference signal to stabilize a repetition rate difference between the first comb and the second comb and/or a difference in carrier envelope offset frequency between the first comb and the second comb.

17. The phase coherent dual comb system according to claim 16, further comprising a second detector configured to record a second interference signal of two combs lines originating from the first and second combs at a second location in optical frequency space, the control system configured to use the first and second interference signals to stabilize both the repetition rate difference between the first comb and the second comb and the difference in carrier envelope offset frequency between the first comb and the second comb.

18. The phase coherent dual comb system according to claim 16, wherein the control system is further configured to stabilize a resonant offset frequency of at least one of the first comb and the second comb.

19. A photonics-based microwave receiver system comprising:
a dual comb generator, comprising:
a 1st comb and a 2nd comb, said 1st comb and said 2nd comb configured to operate at different repetition rates; and at least one electro-optic modulator configured to receive a microwave signal under test (SUT) and to modulate the SUT onto at least one of the comb lines from said 1st comb;
a first wavelength division multiplexing (WDM) system configured to receive a first optical input directly traceable to an output of said 1st comb, the first WDM system configured to separate the first optical input into a 1^{st} set of wavelength channels;
a second wavelength division multiplexing (WDM) system configured to receive a second optical input directly traceable to an output of said 2^{nd} comb, the second WDM system configured to separate the second optical input into a 2^{nd} set of wavelength channels, said 1^{st} and 2^{nd} set of wavelength channels configured to substantially overlap spectrally,
the output of said 1^{st} and 2^{nd} set of wavelength channels further directed to a substantially corresponding set of optical-to-electrical converters (OECs), said set of OECs configured to record optical interference signals between said 1^{st} and 2^{nd} set of wave length channels and to convert their inputs to electrical signals; and
a system to control or monitor the optical phase of said interference signals.

20. The system according to claim 19, wherein said dual comb generator comprises a single microresonator.

21. The system according to claim 19, wherein said dual comb generator comprises two microresonators.

22. The system according to claim 19, wherein said dual comb generator comprises silicon photonics, silica nitride, diamond microstructures or any other microstructures.

23. The system according to claim 19, wherein said system is further configured to be a component of a microwave transceiver.

24. The system according to claim 19, wherein said system further comprises at least one continuous wave (CW) laser configured for injection into at least one of the combs of said dual comb generator.

25. The system according to claim 19, wherein said electro-optic modulator comprises an IQ modulator.

26. The system according to claim 19, wherein said system is further configured as an analog to digital converter for said SUT, the system further comprising:
a set of analog to digital converters (ADCs) substantially corresponding to said set of OECs, said set of ADCs configured to produce a set of digitized outputs; and
at least one digital signal processor located downstream of said set of ADCs and configured to analyze digitized data from said set of ADCs and to produce an output representative of at least an amplitude or a phase or amplitude and phase of said SUT.

27. The system according to claim 26, wherein at least one ADC of the set of ADCs comprises an I/Q detection system.

28. The system according to claim 26, wherein the system is configured to analyze broadband microwave signals with a bandwidth up to several hundred GHz.

29. The system according to claim 19, wherein the system is further configured as a microwave transmitter, the system further comprising an antenna configured to receive as input a microwave signal directly traceable to the output of at least one OEC of said set of OECs and configured to transmit said microwave signal as radio waves.

30. The system according to claim 19, wherein the system is configured to transmit a broadband microwave signal with a bandwidth up to several hundred GHz.

31. A microwave receiver configured to receive a microwave signal under test (SUT), the microwave receiver comprising:
a dual comb generator comprising a 1st comb and a 2nd comb, said 1st comb and said 2nd comb configured to operate at different repetition rates;
a 1^{st} WDM system configured to receive a first optical input directly traceable to an output of said 1st comb, and to separate the first optical input into a first set of wavelength channels;
a 2^{nd} WDM system configured to receive a second optical input directly traceable to an output of said 2^{nd} comb, and to separate the second optical input into a second set of wavelength channels,
a set of OECs configured to receive, as a first input, a first signal directly traceable to an output of said first set of wavelength channels and, as a 2nd input, a second signal directly traceable to an output of said second set of wavelength channels;
a system to control and/or monitor an optical phase between said 1^{st} and 2^{nd} inputs to said OECs,
said set of OECs configured to convert their input to electrical signals;
a set of analog to digital converters (ADCs), configured to receive as input a signal directly traceable to an output of at least one of said set of OECs, the set of ADCs configured to produce a set of digitized outputs; and
a digital signal processor configured to receive said set of digitized outputs and to produce an output representative of at least an amplitude and/or a phase of said SUT.

32. The microwave receiver according to claim 31, wherein at least one of the set of ADCs comprises an I/Q detection system.

33. The microwave receiver according to claim 32, wherein the I/Q detection system comprises an optical hybrid.

34. A phase coherent dual comb system comprising:
a dual comb generator comprising a 1st comb and a 2nd comb, said 1st comb and said 2nd comb configured to operate at different repetition rates;
said 1st and 2nd combs each comprising a corresponding set of comb lines; and
at least one detector configured to record a 1^{st} interference signal of two combs lines originating from the 1st and 2nd combs at a first location in optical frequency space,
said 1^{st} interference signal being used to stabilize a repetition rate difference between said 1st and 2nd combs and/or a difference in carrier envelope offset frequency between said 1st and 2nd combs.

35. The phase coherent dual comb system according to claim 34, further comprising a second detector configured to record a 2^{nd} interference signal of two combs lines originating from the 1st and 2nd combs at a 2^{nd} location in optical frequency space, said 1^{st} and 2^{nd} interference signal being used to stabilize both the repetition rate difference between said 1st and 2nd combs and the difference in carrier envelope offset frequency between said 1st and 2nd combs.

36. The phase coherent dual comb system according to claim 34, further comprising elements to stabilize a resonant offset frequency of at least one of the 1st and 2nd combs.
